(19) United States
(12) Patent Application Publication
(10) Pub. No.: US 2006/0266979 A1
(43) Pub. Date: Nov. 30, 2006

(54) Ceramic powder emitting far infrared ray, high-density bio-stone manufactured by using the same and manufacturing method thereof

(75) Inventor: Chang Ho Ra, Buchon-City (KR)

Correspondence Address: BACON & THOMAS, PLLC, 625 SLATERS LANE, FOURTH FLOOR, ALEXANDRIA, VA, 22314, US

(73) Assignees: BANSEOK ZEROPA CO., LTD., Buchon-City (KR); Chang Ho Ra, Buchon-City (KR)

(21) Appl. No.: 11/441,018

(22) Filed: May 26, 2006

(30) Foreign Application Priority Data
May 27, 2005 (KR) 10-2005-0045169

(51) Int. Cl. C09K 11/77

(52) U.S. Cl. 252/301.4 R

(57) ABSTRACT

Disclosed is a process for manufacturing high-density biostone with ceramic powder emitting a far infrared ray, comprising preparing the ceramic powder by mixing 85˜92% by weight of Al₂O₃, 3˜7% by weight of SiO₂, 3˜7% by weight of MgO and 1˜4% by weight of clay as major ingredients and ball milling it for 48 hrs; adding 0.6% by weight of dispersants, 1% by weight of wetting agents, 0.6% by weight of glycerin, 20% by weight of binders and 0.5% by weight of anti-forming agents as minor ingredients based on 100% by weight of the ball milled mixture to 35% by weight of water of 60° C., stirring it and adding it to the ball milled mixture; and wet grinding the resulting mixture with ball mill about 24 hrs and spray drying it to obtain a ceramic powder having a diameter of about 60 to 80 meshes; introducing the mixed ceramic powder into a shape of mold and pressurizing and compression molding it with a pressure of 0.8×10³ Kg/cm² to 1.2×10³ Kg/cm² to obtain ceramic forms; and loading the forms an airtight sintering furnace and sintering it at 1580° C. to 1600° C. for 12 hrs under oxidizing atmosphere. The biostone manufactured by such ceramic powders emits far infrared ray emissivity and emission energy suitable for human body, and minimizes and delays a production of oxidation materials as long term thermal oxidation of edible oils and fats when it is used in a cooking procedure using edible oils and fats.

### BACKGROUND OF THE INVENTION

1. Field of the Invention

The present invention relates to a ceramic powder emitting a far infrared ray, high-density biostone manufactured by using the ceramic powder and manufacturing method thereof. In particular, the present invention relates to a manufacturing method of high-density and high-strength biostone which is resistant to any impact, manufactured by using the ceramic powder which its toxic elements are removed by high temperature sintering and which emits a far infrared ray at high efficiency.

2. Background of the Related Art

Our ancestors are prone to prefer stone for a long time ago, and when they have a stomachache and a sudden indigestion, they have been got a stone from a riverside and warmed it and wrapped it with towel, and put it on the sick region. Also, a warmed stone has been used to ameliorate pains including muscle pain following laborious physical work, a cryptogenic pain, or the like, and has been exhibited treating effects. Our ancestors have been utilized the treating effects of a warmed stone not based on scientific knowledge, but based on experiences. However, the treating effect of a warmed stone was caused practically by far infrared ray emitted from a warmed stone.

A far infrared ray is an infrared ray having long wavelength, and characterized by strong penetration power in vivo. That is, on exposing to a far infrared ray, heat is transferred to human body due to its strong penetration power, and such thermal function is help to remove bacteria which are cause to trigger various diseases, and has capillary vessel dilate to help for blood circulation and cell tissue generation. Further, it is known that if a far infrared ray reaches moisture and protein molecules which are comprised of cell, it is possible that a far infrared ray oscillates finely cells with 2,000 times per min to activate cell tissues. The effects of a far infrared ray can be used in various adult diseases including anti-aging, promotion of metabolism, chronic fatigue, or the like. Additionally, it is known that a far infrared ray has effects of promotion of perspiration, amelioration of pains, removal of heavy metals, sound sleep, deodorization, anti-microbial action, anti-fungal action, dehumidification, air conditioning, or the like.

Such radiant property, penetration property, or the like of a far infrared ray described above have been used widely in food drying, heating, thermotherapy, health supplies, food processing, building materials, household supplies and physiological functions of animals and plants.

In particular, the most significant problem in food processing is oxidation of oils and fats by heat cooking procedure. That is, since frying oils and fats are exposed continually and repeatedly to air at high temperature, and moisture contained in food is incorporated into frying oils and fats, chemical reactions such as oxidation, polymerization, hydrolysis, breakdown of molecular structure, or the like occur. Also, it is known that a toxicity of heated oils and fats can cause reduction of digestion rate, inhibition of growth, reduction of diet efficiency, hepatomegaly, cancer, or the like. To delay such oxidation, on frying, fresh oils and fats having high smoke point should be used, frying temperature should not be increased more than its share of high temperature, frying time should be minimized and frying oils and fats are exchanged regularly. Also, it has been reported that oils and fats are treated chemically, for example, with addition of natural or synthetic antioxidants, but it has not been reported that oils and fats are treated physically.

To solve the problems described above, in case where a far infrared ray-emitting body is used in a food cooking procedure, it is possible to reduce cooking time since radiant energy is transferred directly to cooking materials without an intermedium, and also it is possible to exhibit uniform penetration effect since cooking materials can self-heat due to resonance phenomenon if a far infrared ray reaches cooking materials.

As such a beneficial far infrared ray-emitting body, ceramic has been studied, and applied to house and building materials, cooker, fiber, clothing, bedding, medical instruments, fomentation room, or the like.

The present applicant has been developed high efficiency, high-strength and high-density biostone as a far infrared ray-emitting body, which can be used in place of massager using ceramic which has been used to ameliorate pains including muscle pain, back pain or the like, and which can minimize or delay a generation of oxidation materials as edible oils and fats is used for a long time in a heat cooking procedure including frying.

### SUMMARY OF THE INVENTION

Therefore, the present invention has been made in view of the above problems occurring in the prior art, and it is an object of the present invention to provide a ceramic powder which is comprised of characterized ingredients and compositional ratio and which emits a far infrared ray, and high-efficiency, high-strength and high-density biostone which is manufactured by using the ceramic powder.

In particular, it is an object of the present invention to provide ceramic powder which can be molded in a desired size and shape; which its toxic elements are removed by high temperature sintering; which has uniform molding density due to compression molding; which has high-density and high-strength which can be resistant to any impact; and which has high far infrared ray emissivity, the biostone manufactured by using the ceramic powder, and the method for manufacturing the biostone. The biostone of the present invention can promote metabolism or perspiration, reduce cooking time and minimize a generation of oxidation materials, or the like.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a sintering graph of the ceramic of the present invention.

FIGS. 2a and 2b are a side view and a front view of an embodiment of high-density biostone molded according to the present invention, and a perspective view of another embodiment of the present invention.

FIGS. 3 and 4 are far infrared ray emissivity graphs of the biostone according to the present invention.

FIGS. 5a and 5b are acid value comparison graphs in case of adding the biostone according to the present invention.

FIGS. 6a and 6b are peroxide value comparison graphs in case of adding the biostone according to the present invention.

FIGS. 7a and 7b are carbonyl value comparison graphs in case of adding the biostone according to the present invention.

### DETAILED DESCRIPTION OF THE PREFERRED EMBODIMENT

Reference will now made in detail to the preferred embodiment of the present invention with reference to the attached drawings.

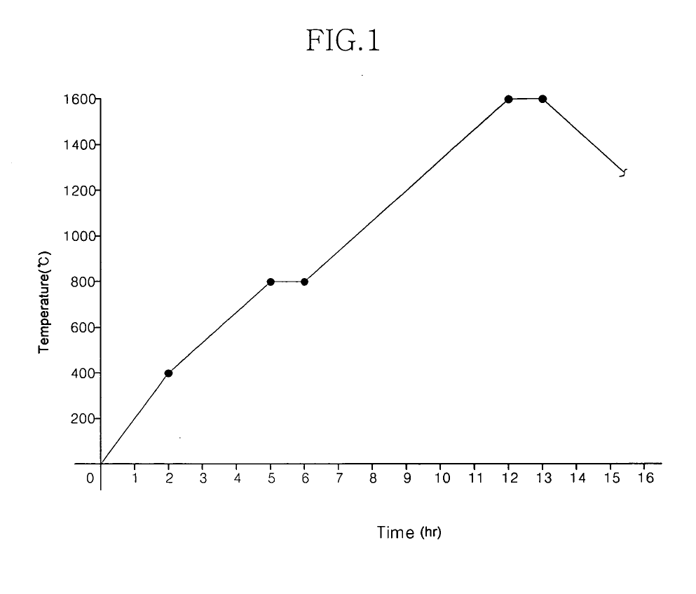

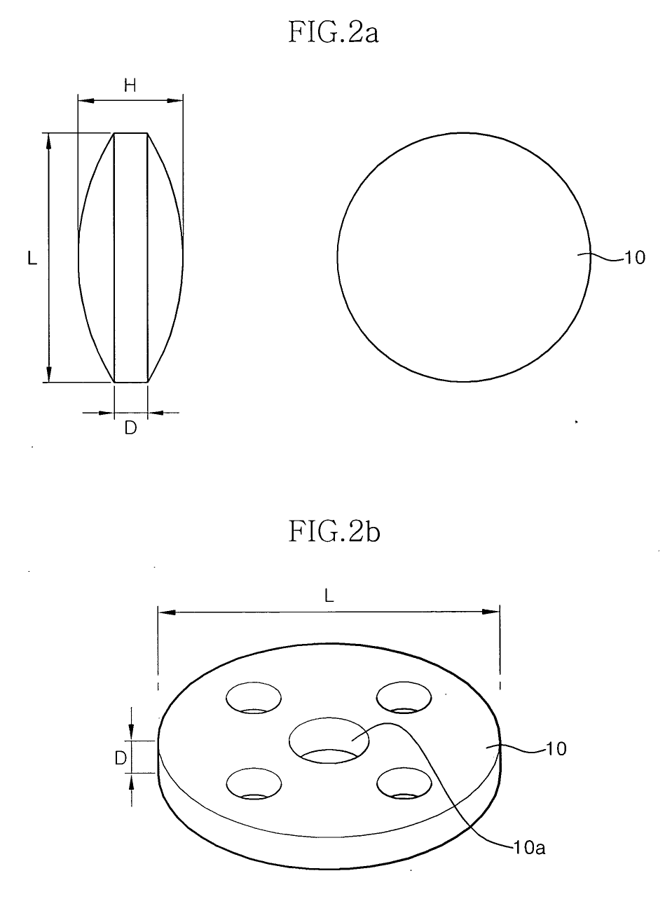

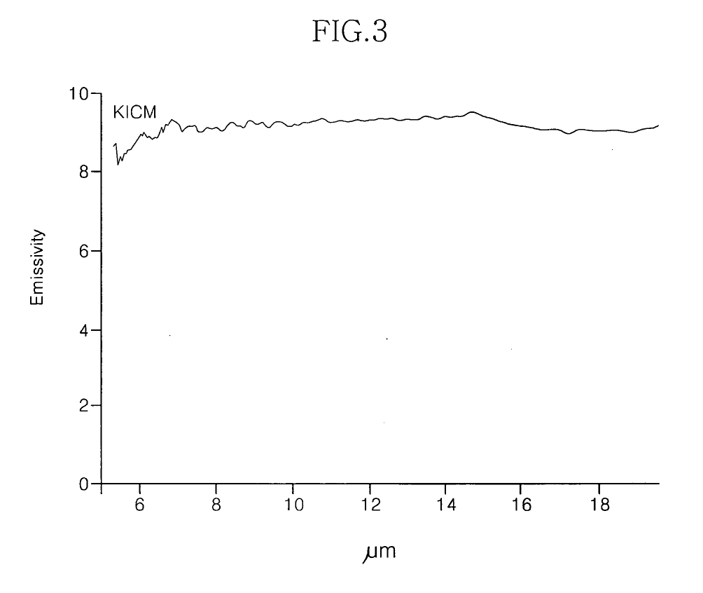

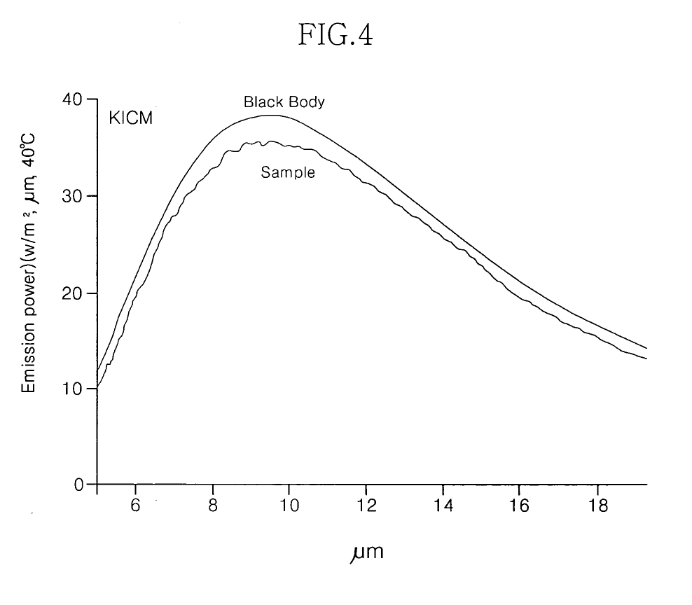

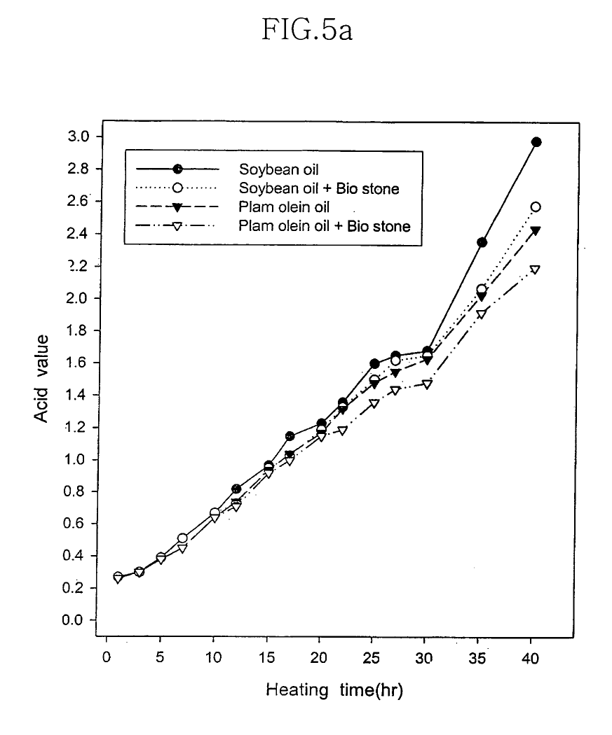

FIG. 1 is a sintering graph of the ceramic of the present invention; FIG. 2a is a side view and a front view of an embodiment of high-density biostone according to the present invention; FIG. 2b is a perspective view of another embodiment of high-density biostone according to the present invention; FIGS. 3 and 4 are far infrared ray emissivity graphs of the biostone according to the present invention.

To manufacture the ceramic powder emitting a far infrared ray of the present invention, the present applicant selected Al₂O₃, SiO₂, MgO and clay as major ingredients, and dispersants, wetting agents, glycerin, binders and anti-foaming agents as minor ingredients. These ingredients were selected experimentally as suitable ingredients to achieve the objects of the present invention.

That is, the ceramic powder emitting a far infrared ray was manufactured by mixing 85˜92% by weight of Al₂O₃, 3˜7% by weight of SiO₂, 3˜7% by weight of MgO and 1˜4% by weight of clay as major ingredients and ball milling the mixture for 48 hrs; adding 0.6% by weight of dispersants, 1% by weight of wetting agents, 0.6% by weight of glycerin, 20% by weight of binders and 0.5% by weight of anti-forming agents as minor ingredients based on 100% by weight of the ball milled mixture to 35% by weight of water of 60° C., and adding it to the ball milled mixture stirring it; and wet grinding the resulting mixture with ball mill about 24 hrs and spray drying it to obtain a ceramic powder having a diameter of about 60 to 80 mesh. In this case, based on 100% by weight of the major ingredients, 0.8% by weight of the black pigment of pigment No. 78 as a minor ingredient was added to color forms with black. A color of a pigment can be selected according to an embodiment of the present invention.

In this case, an inlet temperature of a spray drier is ambient temperature, an outlet temperature of a spray drier is 120° C. to 150° C., an eruption pressure of a spray drier is 25 Kg/cm², and a diameter of a nozzle is 0.8 mm.

Considering a molding efficiency, a diameter of the ceramic powder of the present invention is the most preferably 60 to 80 meshes. If the diameter is 60 meshes or less, it is not convenient to mold due to destruction of raw materials, and if the diameter is 80 meshes or more, a molding weight of a molded product becomes changing.

To obtain a molded product having a desired shape from the ceramic powder, firstly the ceramic powder and 0.7% by weight of a lubricant based on 100% by weight of the ceramic powder are introduced into a mixer, and the mixture is mixed for 25 min. And then, the mixture is loaded into a desired mold and compression molded with a pressure of 0.8×10³ Kg/cm² to 1.2×10³ Kg/cm² and the resulting forms are removed from the mold. The pressure range is for making a density of a sintering body uniform and preventing a crack or a breakdown of the sintering body under high temperature sintering procedure of the ceramic powder comprised of the above ingredients.

The forms are loaded into an airtight sintering furnace, and a temperature in the sintering furnace is increased to 1580° C. to 1600° C. over 12 hrs. In this case, as illustrated in the sintering graph (FIG. 1; x-axis is time and y-axis is temperature), about 800° C., namely the temperature which the loaded forms in the sintering furnace begins to be contracted, is maintained constantly for approximately 1 hr to prevent crack or the like on contraction. And then, the temperature in the sintering furnace is increased again until the temperature is reached 1580° C. to 1600° C., and the temperature is maintained constantly again for approximately 1 hr. It is for transferring high temperature uniformly up to inside of forms to be sintered to carry out sintering procedure efficiently. As described above, after sintering the forms up to 1580° C. to 1600° C. over 12 hrs, the temperature in the sintering furnace is cooled slowly until the temperature is reached 200° C. And then, if the temperature in the sintering furnace reaches 200° C., a door of the sintering furnace is opened, the sintered forms are removed from the sintering furnace and are cooled slowly at room temperature to obtain high quality and high-strength biostone emitting a far infrared ray at high efficiency. The resulting biostone has high-density with 3.2 of specific gravity, and high-strength of about 294 Mpa.

In this case, a lubricant is added to the ceramic powder because of supply of moisture which is necessary for powder molding, effective removal of forms from a mold and prevention of cracks on molding.

The biostone emitting a far infrared ray of the present invention is manufactured by using the ceramic powder and scientific sintering methods as described above. The biostone can be molded in a shape of convex lens with constant thickness as illustrated in FIG. 2a or a shape of disc with constant thickness having a plurality of openings 10a as illustrated in FIG. 2b. Additionally, the biostone of the present invention can be molded in various shapes including sphere, polygon or the like according to an embodiment of the present invention.

The biostone manufactured according to the present invention can apply to various applications. The biostone can be referred to a far infrared ray-emitting bioceramic, a far infrared ray-emitting stone, a far infrared ray-emitting massage stone, a far infrared ray-emitting fomentation stone, a far infrared ray-emitting physical therapy stone or the like.

### <EXAMPLES>

First, a ceramic powder emitting a far infrared ray was prepared by mixing 85˜92% by weight of Al₂O₃, 3˜7% by weight of SiO₂, 3˜7% by weight of MgO and 1˜4% by weight of clay as major ingredients and ball milling it for 48 hrs; adding 0.6% by weight of dispersants, 1% by weight of wetting agents, 0.6% by weight of glycerin, 20% by weight of binders and 0.5% by weight of anti-forming agents as minor ingredients based on 100% by weight of the ball milled mixture to 35% by weight of water of 60° C., stirring it and adding it to the ball milled mixture; and wet grinding the resulting mixture with ball mill about 24 hrs and spray drying it to obtain a ceramic powder having a diameter of about 60 to 80 meshes. In this case, 0.8% by weight of the black pigment of pigment No. 78 as minor ingredient was added to color forms with black.

In this case, an inlet temperature of a spray drier is ambient temperature, an outlet temperature is a spray drier is 120° C. to 150° C., an eruption pressure of a spray drier is 25 Kg/cm² and a diameter of a nozzle is 0.8 mm.

To obtain a desired shape from the ceramic powders, the ceramic powders were introduced into a mixer with 0.7% by weight of a lubricant and mixed it for 25 min. And then, the mixture was loaded into a convex lens shape mold having a constant thickness, compression molded with 0.8×10³ Kg/cm² of pressure and the resulting forms were removed from the mold. The forms were loaded into an airtight sintering furnace. For effective sintering under oxidation atmosphere (atmospheric gas), a sintering was carried out by increasing a temperature of forms loaded in the sintering furnace to 400° C. over 2 hrs, and 800° C. over 3 hrs and then maintaining the temperature of the sintering furnace for 1 hr, and increasing a temperature in the sintering furnace to 1600° C. over 6 hrs and subsequently maintaining the temperature for 1 hr. And then, a temperature in a sintering furnace was cooled slowly until a temperature in a sintering furnace becomes 200° C., and then opening a door of the sintering furnace to cool it naturally and slowly to produce a convex lens shape biostone 10 (a diameter of disc (L)×a length between top and bottom convex points (H)×a thickness of disc (D)) having dimensions of 70 mm×28 mm×9.4 mm, 60 mm×20 mm×6.8 mm, 45 mm×15 mm×5 mm, and 25 mm×8 mm×2.4 mm, and emitting a far infrared ray with high efficiency and high intensity as shown in FIG. 2. The resulting biostone has high-density with 3.2 of specific gravity.

Also, a disc shape biostone 10 (a diameter (L)×a thickness of disc (D)) which has a plurality of openings 10a having dimensions of 110 mm×12 mm, and emitting a far infrared ray with high efficiency and high intensity as shown in FIG. 2. A plurality of openings 10a is convenient to prevent a bumping phenomenon in heating procedure.

Various physical properties of a high-density and high-strength biostone manufactured by the present invention were determined, and the results were recorded in the following table 1.

TABLE 1

| | | | | Water | | |
|---|---|---|---|---|---|---|
| | | | | Ab- | | Tough- |
| | | Specific | | sorption | Temp. | ness |
| | Color | Gravity | Endurance | Power | Expansion | Strength |
| Test | Black | 3.2 | 1100 HV | 0 | 7.3 × 10⁻⁶/ | 294 Map |
| results | | | | | ° C. | |

Also, a test to confirm whether a high-density and high-strength biostone manufactured by the present invention has Pb and Cd which are harmful to human body, was carried out, and the results were recorded in the following table 2.

TABLE 2

| | Unit | Standard | Test results |
|---|---|---|---|
| Pb | μg/cm² | 1.7 | Not detected |
| | | or less | (detection limit 1) |
| Cd | μg/cm² | 1.7 | Not detected |
| | | or less | (detection limit 0.1) |

The Pb and Cd detection test was carried out according to Food Code (Ch. 6, Equipments and containers, standard and criteria of wrapping). As shown in the results, all toxic elements of mineral were removed from the biostone due to high temperature sintering of 1580° C. or more.

Further, an emitting rate and an emitting power of the resulting biostone were determined, and the results were compared with those of a black body. The results were recorded in the following table 3, and emitting rate graphs were depicted in FIGS. 3 and 4.

TABLE 3

| Emissivity | Emission output |
|---|---|
| 5˜20 μm | (W/m² μm 40° C.) |
| 0.93 | 3.74 × 10² |

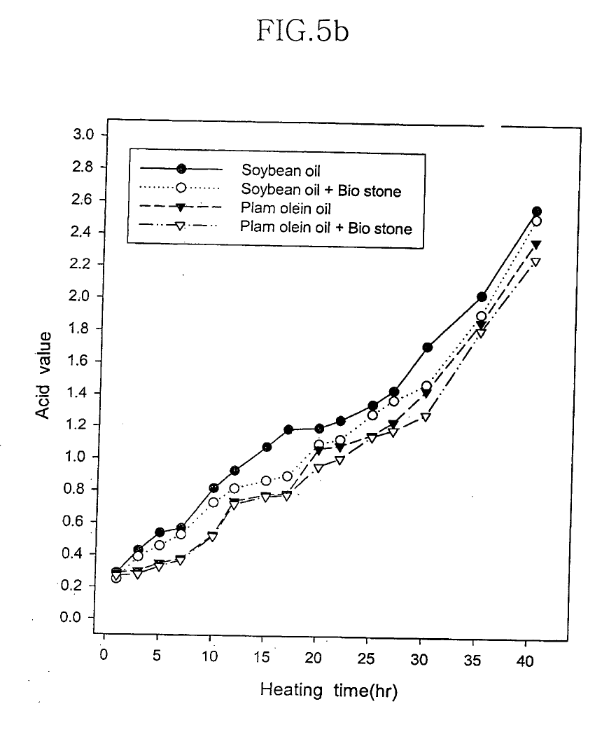

Also, to confirm the effect of the biostone when it is used in a heating procedure, in particular frying, a frying oil containing the biostone (treated case) and a frying oil containing no biostone (control) are used in a frying. The results were shown in FIGS. 5 to 7b.

FIGS. 5 to 7b were graphs exhibiting the effect of the test in case where the biostone was added to frying oils. X-axis exhibits heating time, and Y-axis exhibits acid value, peroxide value, and carbonyl value respectively.

At first, general properties of oils and fats are as following: as oils and fats are used for a long time, viscosity of oils and fats becomes increasing, smoke point of oils and fats becomes decreasing and persistent bubbling phenomenon occurs. Also, a content of saturated fatty acids among fatty acids is a little changed, but a content of unsaturated fatty acids decreases rapidly. Acid value and carbonyl value become increasing, and peroxide value exhibits maximum value and then becomes decreasing. These phenomena are causes to deteriorate the quality of oils and fats, and cause acidification of oils and fats. Therefore, acid value, peroxide value, carbonyl value and smoke point were compared as results of the test.

(1) Materials and Methods of the Test

Soybean oils commonly used at general home and palmolefine oils commonly used at industrial sites were used as test oils. Chicken legs and potatoes were used as frying materials. Conditions of oils were observed for 40 hrs. The conditions listed up in the following table 4 were applied to frying methods.

TABLE 4

| | | Time | Amount of | Amount of |
|---|---|---|---|---|
| Material | Temp. | interval | Oils(L) | material |
| Chicken | 170° C. | 20 min | 4 L | 5 pieces |
| Legs | | | | |
| Potatoes | 190° C. | 10 min | 4 L | 300 g |

(2) Test Results

[Acid Value]

As shown in FIGS. 5a and 5b, an increasing level of acid value for respective oils for 40 hrs was as follows; in case of chicken legs, soybean oils was 0.27-2.98 and soybean oils+biostone was 0.27-2.58; palmolefine oils was 0.26-2.44 and palmolefine oils+biostone was 0.26-2.20, and in case of potatoes, soybean oils was 0.29-2.58 and soybean oils+biostone was 0.25-2.52; palmolefine oils was 0.29-2.38 and palmolefine oils+biostone was 0.27-2.27. As shown in the results, biostone-containing oils exhibit lower increment of acid value in comparison with that of control.

[Peroxide Value]

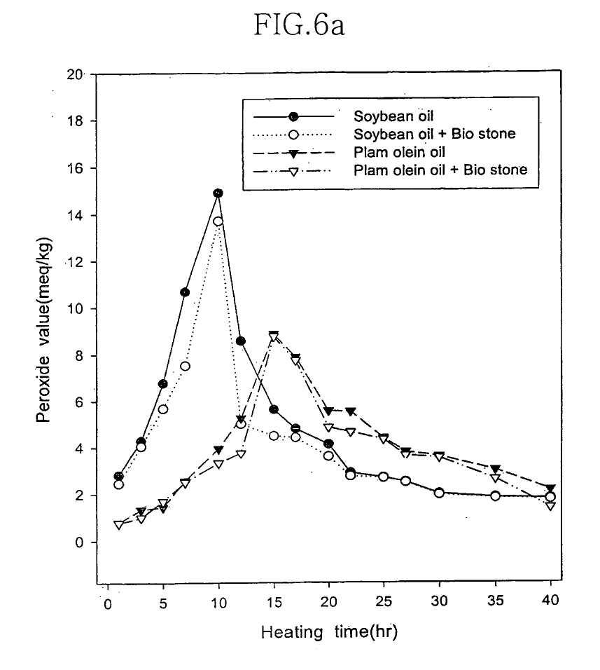

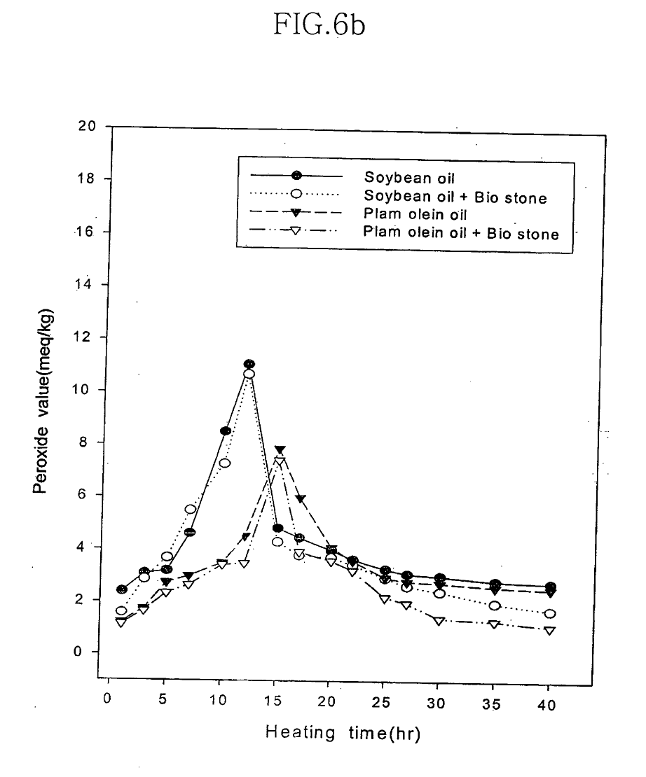

As shown in FIGS. 6a and 6b, peroxide value for respective oils for 40 hrs were as follows; in case of chicken legs, soybean oils was 2.81-14.91 and soybean oils+biostone was 2.45-13.71, which were decreased to 1.79 and 1.75 respectively following 10 hrs; palmolefine oils was 0.78-7.89 and palmolefine oils+biostone was 0.76-7.73, which were decreased to 2.16 and 1.40 respectively following 17 hrs, and in case of potatoes, soybean oils was 2.40-11.07 and soybean oils+biostone was 1.58-10.70, which were decreased to 2.78 and 1.73 respectively following 12 hrs; palmolefine oils was 1.27-7.87 and palmolefine oils+biostone was 1.41-7.42, which were decreased to 2.55 and 1.12 respectively following 15 hrs. As shown in the results, biostone-containing oils exhibit lower increment of peroxide value in comparison with that of control.

[Carbonyl Value]

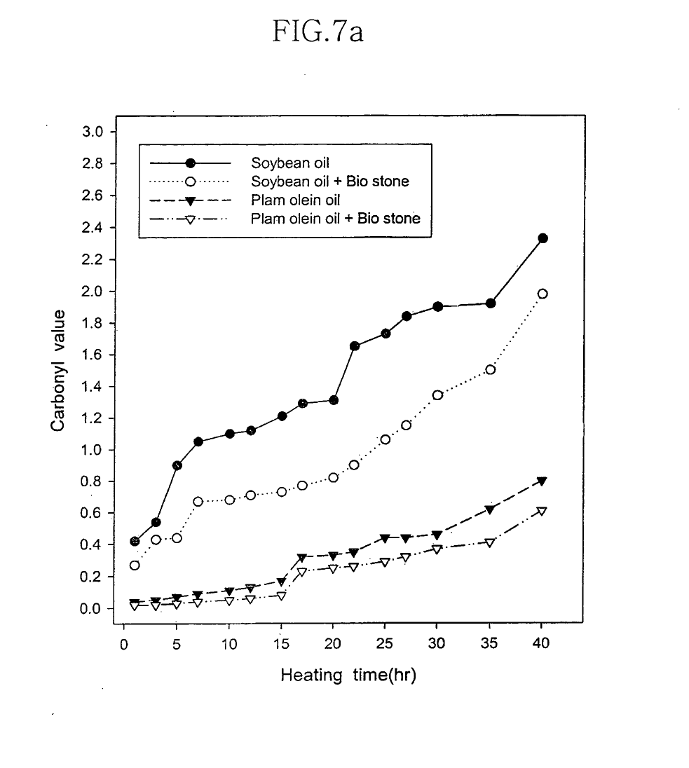

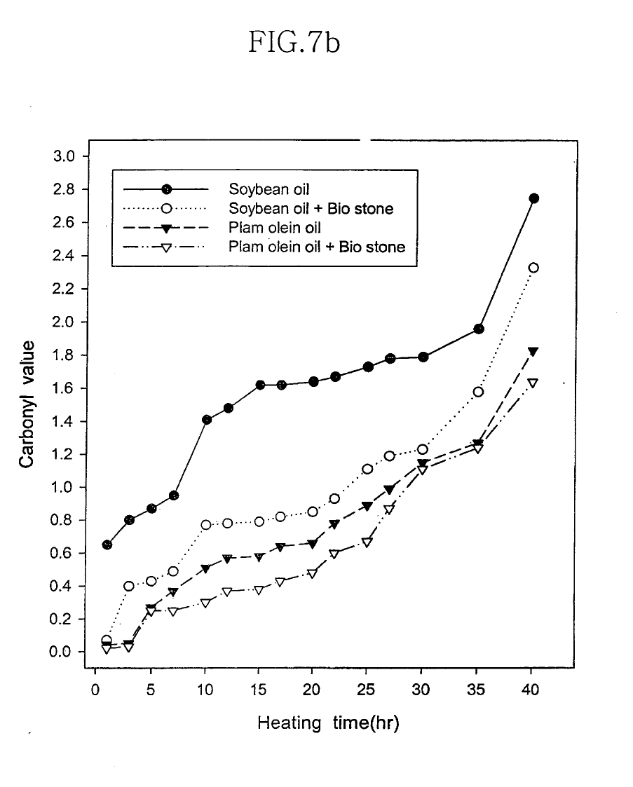

As shown in FIGS. 7a and 7b, carbonyl value for respective oils for 40 hrs was as follows; in case of chicken legs, soybean oils was 0.42-2.33 and soybean oils+biostone was 0.27-1.98; palmolefine oils was 0.04-0.80 and palmolefine oils+biostone was 0.02-0.61, and in case of potatoes, soybean oils was 0.65-2.75 and soybean oils+biostone was 0.07-2.33; palmolefine oils was 0.04-1.83 and palmolefine oils+biostone was 0.02-1.64. As shown in the results, biostone-containing oils exhibit lower increment of carbonyl value in comparison with that of control.

[Smoke Point]

Smoke point of raw oils without heating was 204° C., and changes of smoke point as heating time for 40 hrs were as follows: in case of chicken legs, soybean oils was 200° C.-162° C. and soybean oils+biostone was 200° C.-164° C.; palmolefine was 200° C.-170° C. and palmolefine+biostone was 200° C.-172° C.; in case of potatoes soybean oils was 200° C.-170° C. and soybean oils+biostone was 200° C.-172° C.; palmolefine was 200° C.-174° C. and palmolefine+biostone was 200° C.-176° C. As shown in the results, biostone-containing oils exhibit approximately 2° C. higher smoke point in comparison with that of control.

Additionally, it was proved experimentally that there was distinct color difference between biostone-containing oils and control for color value.

As shown the results described above, when biostone, that is a far infrared ray-emitting body of the present invention, is applied to heating procedures such as frying or the like, the biostone of the present invention minimizes or delays a generation of oxidation material as long term heating of oils and fats in comparison with conventional cooking methods, in case where same cooking energy and same cooking time are applied.

The biostone prepared by using the ceramic powder of the present invention can be used in treating human body, since all toxic elements were removed from the biostone due to high temperature sintering. Also, the biostone has high far infrared ray emissivity and high emitting energy, and can be used in place of Bu-hang or massaging machine which are conventionally used in ameliorating pains such as muscle pain, back pain or the like.

Also, when the biostone of the present invention is used in cooking procedures using edible oils and fats such as frying or the like, the biostone minimizes or delays a generation of oxidation material as long term heating of oils and fats, and both inside and outside of materials can be heated uniformly, since increased heat energy can be absorbed effectively into materials and penetrating power is strong.

Also, the biostone of the present invention can be commercialized into various far infrared ray-emitting bodies by using its high-density and high-strength.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A ceramic powder emitting a far infrared ray comprising 85˜92% by weight of Al₂O₃, 3˜7% by weight of SiO₂, 3˜7% by weight of MgO and 1˜4% by weight of clay as major ingredients, and 0.6% by weight of dispersants, 1% by weight of wetting agents, 0.6% by weight of glycerin, 20% by weight of binders and 0.5% by weight of anti-forming agents as minor ingredients based on 100% by weight of the major ingredients.

2. A process for manufacturing high-density biostone with ceramic powder emitting a far infrared ray, comprising
(a) preparing the ceramic powder according to claim 1;
(b) wet grinding the prepared ceramic powder for 24 hrs and then spray drying it to obtain the ceramic powder;
(c) adding 0.7% by weight of a lubricant, based on 100% by weight of the ceramic power, to the ceramic powder and mixing it;
(d) introducing the mixed ceramic powder into a shape of mold and pressurizing and compression molding it with a pressure of 0.8×10³ Kg/cm² to 1.2×10³ Kg/cm² to obtain ceramic forms;
(e) loading the forms an airtight sintering furnace and sintering it at 1580° C. to 1600° C. for 12 hrs under oxidizing atmosphere;
(f) cooling slowly a sintering furnace until a temperature in a sintering furnace becomes 200° C., and then opening a door of the sintering furnace to cool it naturally and slowly,
wherein the step (a) comprises the first preparation step mixing 85˜92% by weight of Al₂O₃, 3˜7% by weight of SiO₂, 3˜7% by weight of Mgo and 1˜4% by weight of clay as major ingredients and ball milling it for 48 hrs; and the second preparation step adding 0.6% by weight of dispersants, 1% by weight of wetting agents, 0.6% by weight of glycerin, 20% by weight of binders and 0.5% by weight of anti-forming agents as minor ingredients based on 100% by weight of the ball milled mixture to 35% by weight of water of 60° C. and stirring it.

3. The process for manufacturing high-density biostone with ceramic powder emitting a far infrared ray according to claim 1, comprising further adding 0.8% by weight of pigment as minor ingredient to color the forms.

4. The process for manufacturing high-density biostone with ceramic powder emitting a far infrared ray according to claim 2, the step (e) is carried out by increasing a temperature of forms loaded in the sintering furnace to 400° C. over 2 hrs, and 800° C. over 3 hrs and then maintaining the temperature of the sintering furnace for 1 hr, and increasing a temperature in the sintering furnace to 1600° C. over 6 hrs and subsequently maintaining the temperature for 1 hr.

5. A high-density biostone with ceramic powder emitting a far infrared ray prepared according to the process of claim 2 having a shape of convex lens with a constant thickness.

6. The high-density biostone with ceramic powder emitting a far infrared ray according to claim 5, the shape of biostone is a shape of disc with a constant thickness.
